(19) United States
(12) Patent Application Publication
(10) Pub. No.: US 2026/0371006 A1
(43) Pub. Date: Nov. 19, 2026

(54) CAMERA BASED MICROPHONE FIELD OF LISTEN

(71) Applicant: Motorola Mobility LLC, Chicago, IL (US)

(72) Inventors: Ranjeet Gupta, Aurora, IL (US); Rahul Bharat Desai, Hoffman Estates, IL (US); Giles Tucker Davis, Downers Grove, IL (US)

(73) Assignee: Motorola Mobility LLC, Chicago, IL (US)

(21) Appl. No.: 19/206,317

(22) Filed: May 13, 2025

(51) Int. Cl. H04R 1/40; G06F 3/01; G06F 21/32; H04R 5/027

(52) U.S. Cl. CPC H04R 1/406; G06F 3/013; G06F 21/32; H04R 5/027; H04R 2430/21

(57) ABSTRACT

Techniques for camera based microphone field of listen are described. In implementations, a computing device is operable to detect sound sampled using a microphone array including at least three microphones, compute a field of view projected by a camera in a three-dimensional space external to the computing device, and project a field of listen of the microphone array within boundaries of the three-dimensional space that define the field of view. The computing device is further operable to further sample the sound as a speech input based on whether a sound propagation path of the sound enters the field of listen or misses the field of listen, and execute an operation based on the speech input.

### BACKGROUND

Conventional device audio input systems often utilize four microphones arranged as three orthogonal pairs to localize sound direction in a three-dimensional space. While conventional approaches enhance audio processing through adoption of microphone arrays, other potential security and privacy vulnerabilities may be introduced. When multiple voice-activated devices operate in proximity, conflicting speech input activations can occur as conventional systems of the multiple devices struggle to determine whether to respond or allow the other device to respond to a particular voice command. Disambiguating between the correct recipient of the voice command is difficult in noisy environments and when managing interactions with co-located devices.

### BRIEF DESCRIPTION OF THE DRAWINGS

Aspects of camera based microphone field of listen are described with reference to the following Figures. The same numbers may be used throughout to reference similar features and components that are shown in the Figures. Further, identical numbers followed by different letters reference different instances of features and components described herein.

FIG. 1 illustrates a block diagram of an environment that includes computing devices operable to process sound inputs, in accordance with one or more implementations of camera based microphone field of listen.

FIG. 2 depicts a block diagram of a system for processing sound inputs, in accordance with one or more implementations of camera based microphone field of listen.

FIG. 3 illustrates a scenario showing a computing device operable to process sound inputs, in accordance with one or more implementations of camera based microphone field of listen.

FIG. 4 illustrates a scenario involving a user and a computing device, in accordance with one or more implementations of camera based microphone field of listen.

FIG. 5 illustrates a flowchart of a process for localizing user voice commands in an always-on camera mode, in accordance with one or more implementations of camera based microphone field of listen.

FIG. 6 illustrates a flowchart of a process for processing sound inputs based on camera and microphone array fields, in accordance with one or more implementations of camera based microphone field of listen.

FIG. 7 illustrates a flowchart of a process for processing sound inputs using microphone and camera systems, in accordance with one or more implementations of camera based microphone field of listen.

FIG. 8 illustrates a scenario showing interaction between multiple computing devices and a user, in accordance with one or more implementations of camera based microphone field of listen.

FIG. 9 illustrates various components of an example device in which aspects of camera based microphone field of listen can be implemented in accordance with one or more implementations.

### DETAILED DESCRIPTION

Techniques related to camera based microphone field of listen are described. In an implementation, a computing device utilizes a microphone array including at least three microphones (e.g., arranged in at least three non-coincident axes of direction, arranged in a linear axes of direction for adaptive processing) to enable sound localization and beamforming by projecting a field of listen for capturing sound. The computing device further includes a camera that projects a field of view for capturing images. The field of view (e.g., a pyramid or cone) defined by horizontal and vertical field of view angles) defines a three-dimensional space that represents the camera observable world. In contrast, a field of listen is projected within boundaries of the three-dimensional space. The microphone array is configured to isolate and further sample sound entering the field of listen, and filter out (e.g., ignore) noise, which when initially sampled that misses the field of listen.

To improve sound capture capability and sound input quality, the computing device is configured to modify an original field of listen to align with boundaries of the field of view. The computing device may compute the camera field of view in three-dimensional space (e.g., external to the computing device). Responsive to detecting a sound sampled using the microphone array, the computing device adjusts the original field of listen by computing a modified field of listen encompassed by the field of view, including by compensating for differences between a camera position and at least one microphone position. In an example scenario, the computing device determines whether a sound propagation path of the sound enters the modified field of listen when sampling the sound for detection. When a sound propagation path misses the modified field of listen, the sound is ignored by refraining from further sampling the sound (e.g., the sound is filtered from the microphone array input). However, when the sound propagation path enters the modified field of listen, the sound is further sampled as a speech input, including causing execution of an operation of the computing device based on the speech input. The sound continues to be sampled using the microphone array from the modified field of listen, and the modified field of listen can be stored by the computing device for efficient retrieval and reuse for processing subsequent sounds. For scenarios with multiple nearby computing devices, the computing device can detect two or more devices with overlapping regions of respective fields of view or fields of listen. Additional sensor data, such as gaze data indicating a user gaze direction, may be used to determine to use the device closer to the gaze direction for responding to the sound. In variations, users detected within the field of view are authenticated using facial recognition and/or voice recognition to enhance security.

Conventional voice-activated devices are prone to malfunctions and security vulnerabilities, particularly in noisy or multi-device environments, leading to issues like unintended recordings, conflicting activations, and device selection confusion, resulting in inconsistent performance and user frustration across different ecosystems and shared spaces. An example computing device addresses these challenges by implementing a modified field of listen approach, enhancing functionality, privacy, and security. By combining camera based microphone field of listen techniques with additional authentication processes, the device filters out sounds outside defined spatial boundaries and overcomes issues related to conflicting activations in shared spaces across diverse ecosystems. As voice interfaces proliferate, the described techniques enable secure, context-aware voice interactions while maintaining user privacy and system reliability, striking a balance between usability and data protection, and offering a robust experience across various applications and device types.

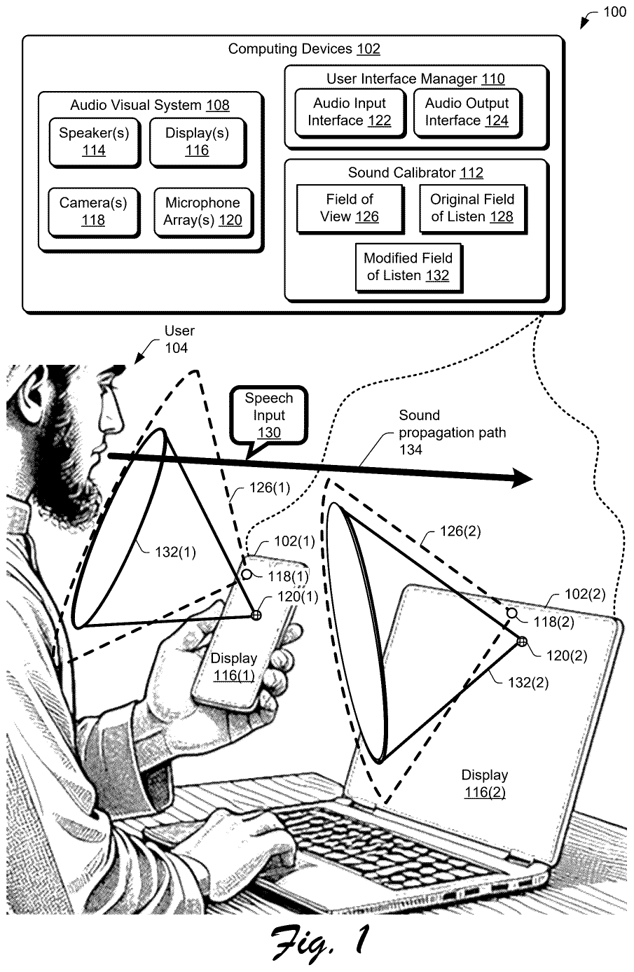

FIG. 1 illustrates a block diagram of an environment 100 that includes computing devices operable to process sound inputs, in accordance with one or more implementations of camera based microphone field of listen. The environment 100 may encompass various settings where voice-activated devices are utilized, such as home environments, office spaces, vehicles, or public areas. Within this environment 100, multiple computing devices 102 coexist, each capable of processing audio inputs and responding to voice commands.

The computing devices 102 may include, but are not limited to, smartphones, tablets, laptops, smart speakers, smart displays, wearable devices, automotive infotainment systems, or other conceivable computing devices configurable to process audio and visual inputs. Each computing device 102 incorporates physical components such as processors, memory, display screens for visual output, speakers for audio output, and input interfaces (e.g., touchscreens, physical buttons, microphones for voice commands) that enable user interaction. The computing devices 102 may execute incompatible operating systems, or support different computing platforms, which prevents direct coordination between the computing devices 102 for determining whether to respond to a sound input or not.

In the illustrated example, the environment 100 shows a first computing device 102(1) (e.g., a mobile phone) and a second computing device 102(2) (e.g., a laptop) in proximity to a user 104. This scenario represents a common situation where multiple voice-activated devices are present in the same space, potentially leading to conflicts in voice command processing. The computing devices 102 each include an audio visual system 108 and a user interface manager 110, which work in concert to provide a seamless and context-aware voice interaction experience on the respective computing devices 102.

The audio visual system 108 comprises an integrated set of components designed to capture and process both audio and visual information. This system includes speakers 114 for audio output, displays 116 for visual feedback, cameras 118 for capturing visual input, and a microphone array 120 for high-quality audio capture.

The speakers 114 may include various types of audio output devices such as built-in smartphone speakers, external Bluetooth speakers, soundbars, or headphones capable of reproducing sound from the computing devices 102. The displays 116 may encompass a range of visual output technologies including LCD screens, OLED panels, e-ink displays, or projector systems that can present information visually to users. The displays 116 provide visual output, which may include visual feedback for voice commands, contextual information, or other relevant data. The cameras 118 capture visual input within respective fields of view, enabling features such as gesture recognition, user identification, and environmental awareness. The cameras 118 may comprise different types of image capture devices such as front-facing (e.g., selfie) cameras, rear-facing high-resolution cameras, wide-angle lenses, depth-sensing cameras, always-on-cameras, or other imaging devices that can capture visual information from the environment 100 in the three-dimensional space that surrounds the computing devices 102. The first computing device 102(1) includes a first display 116(1) and a first camera 118(1), while the second computing device 102(2) includes a second display 116(2) and a second camera 118(2). This configuration allows each of the computing devices 102 to independently capture and process visual information within respective fields of view.

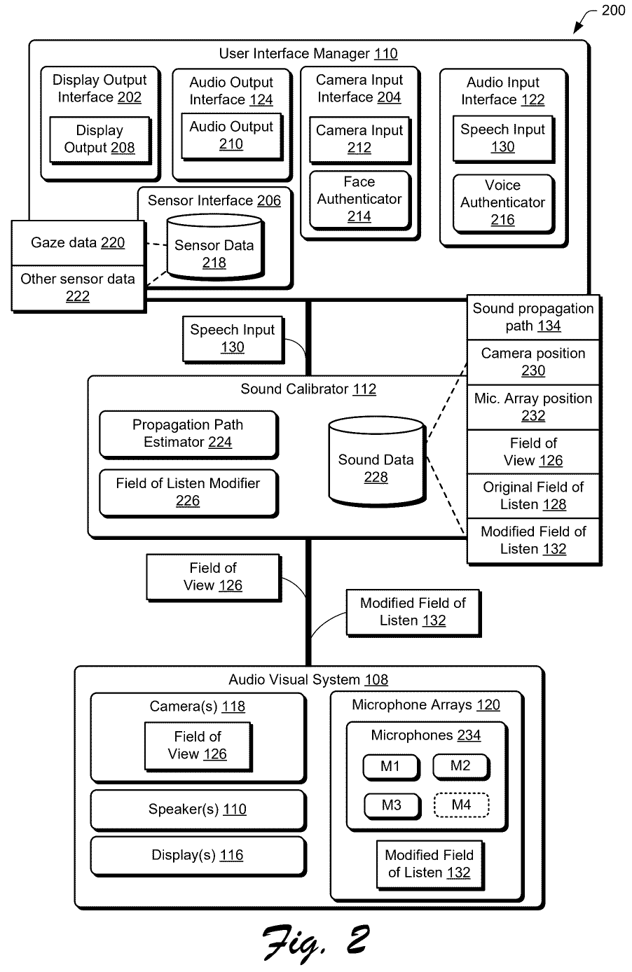

The microphone array 120 may include various configurations such as linear arrays, circular arrays, or planar arrays, each designed to capture audio from different directions and distances. In an implementation, a computing device utilizes a microphone array 120 including at least three microphones. The at least three microphones of the microphone array 120 may be arranged in at least three non-coincident axes of direction to enable sound localization and beamforming by projecting a field of listen for capturing sound. In variations, the microphones are strategically positioned on the device to form a tetrahedral array, with each microphone placed at a vertex of a virtual tetrahedron. This configuration allows for 3D sound localization by analyzing signals from each non-coincident axis of direction, providing a comprehensive spatial representation of the sound environment. For example, the microphone array 120 includes at least four microphones arranged in at least three mutually orthogonal pairs defining the at least three non-coincident axes of direction. The orthogonal pairs of microphones in the microphone array 120 are arranged at different locations on the computing devices 102. As another example, the microphone array 120 includes three directional microphones or four omnidirectional microphones, which are arranged about the device and configured for capturing audio in each of the at least three non-coincident axes of direction. As a third variation, the at least three microphones of the microphone array 120 can be arranged on a single linear axes. The sound propagation path 134 is obtainable from the single linear axes of microphones based on adaptive processing techniques applied for capturing or sampling the sound. For example, the adaptive sound processing techniques enable comparable sound localization and filtering functions as a three non-coincident axes configuration using a microphone array including three (or more) co-linearly arranged micro phones. Each of these example three and four microphone arrangements can include additional or different configurations of microphones, including omnidirectional microphones, directional microphones, and combinations thereof. The configuration and quantity of microphones of the microphone array are 120 are selected that enable advanced audio processing functions such as beamforming (e.g., when capturing audio from the user 104 during a phone call), audio localization (e.g., changing focus of the audio capture between the user 104 and other people participating in the call), orientation sensing (e.g., computing orientation of the devices 102 based on sound signals correlated from the distributed microphone positions). Each example arrangement of three or more microphones as described herein, as well as other quantities and arrangements of microphones, are usable to enable the device to capture audio signals from multiple directions simultaneously, enhancing the system's ability to accurately determine sound sources in three-dimensional space. The microphone array 120 may include additional components, such as additional microphones or filters, to enhance audio capture capabilities and improve spatial audio processing. The microphone array 120 and characteristics such as these are described in greater detail below with reference to FIG. 2.

The user interface manager 110 serves as a central coordinator for user interactions with the computing devices 102, managing both inputs and outputs. An audio input interface 122 and an audio output interface 124 of the user interface manager 110 process incoming audio signals and generate audio responses, respectively, on behalf of the user interface manager 110. For example, the audio input interface 122 receives an audio signal (e.g., the user 104 speaks “hey device”) captured by the microphone array 120, and the audio output interface 124 outputs a response to the audio signal (e.g., an indication of acknowledgment of that the audio signal is received (e.g., the speakers 114 output “hello human, how can I help?”). These interfaces 122 and 124 may employ advanced audio processing techniques such as noise cancellation, echo reduction, and voice enhancement to improve the sound quality and capture quality of voice interactions.

The computing device further includes a camera 118 that projects a field of view 126 for capturing images. The field of view 126 (e.g., a pyramid or cone defined by horizontal and vertical field of view angles) defines a three-dimensional space that represents the camera observable world. Each of the computing devices 102 includes the sound calibrator 112, which is configured to process field of view 126 information, including a first field of view 126(1) from the camera 118(1) of the computing device 102(1) and a second field of view 126(2) from the camera 118(2) of the computing device 102(2). In contrast, a field of listen 128 is projected within boundaries of the three-dimensional space. The field of view 126 can be measured horizontally, vertically, or diagonally. A total visual field of the field of view 126 may include a central vision zone, which is surrounded by one or more peripheral zones that extend the central vision zone in one or more directions (e.g., horizontally, vertically). As one non-limiting example, the field of view 126 of the cameras 118 include a central vision zone of approximately 60°, which is surrounded by one or more peripheral zones that extend the field of view 126 to between approximately 130° and 135° (e.g., in one or both the vertical and horizontal directions). This geometry enables mapping of the observable world to Cartesian coordinates of the surrounding three-dimensional space. The microphone array 120 is configured to isolate and sample sound entering the field of listen 128, and filter out (e.g., ignore) noise sampled with the microphone array 120, which misses the field of listen 128. To improve sound capture capability and sound input quality, the computing device is configured to modify an original field of listen 128 to align with boundaries of the field of view 126, creating a modified field of listen 132. The computing devices 102 process audio and visual information within the environment 100 by coordinating the field of view 126 from the cameras 118 with the modified field of listen 132 from the microphone array 120.

The sound calibrator 112 is triggered by a detection of speech input 130 (e.g., a sound at the microphone array 120) to generate a modified field of listen 132 that improves audio capture discernment and quality associated with the audio input interface 122. For example, the audio input interface 122 processes sound by configuring the microphone array 120 to project an original field of listen 128, which represents the initial audio capture area of the microphone array 120. The original field of listen 128 includes a three-dimensional spatial region where the microphone array 120 is configured to detect and process sound inputs. For example, on power-up or initialization of the computing devices 102, the microphone array 120 is configured to project the original field of listen 128 having a default size, direction, dimension, or other parameter that is generalized across typical contexts of the computing devices 102. The microphone array 120 includes at least three microphones arranged as including at least three non-coincident axes of direction, and the original field of listen 128 of the at least four microphones is initially defined by a particular pickup pattern programmable with the microphones. In some examples, the computing devices 102 process speech input 130 detected in response to a sound sampled by the microphone array 120, which travels along a sound propagation path 134. Illustrated in FIG. 1, the sound propagation path 134 represents the trajectory (including a direction relative to the three-dimensional space external to the computing devices 102) of sound waves from the user 104 to the computing devices 102 as the user speaks the speech input 130. The sound propagation path 134 is used by the sound calibrator 112 for accurately localizing the speech input 130 to the user 104 or to another audio source speaking in the environment 100.

In response to the detection of the speech input 130, the sound calibrator 112 is configured to generate the modified field of listen 132, such as, a first modified field of listen 132(1) for the computing device 102(1) and a second modified field of listen 132(2) for the computing device 102(2). The modified field of listen 132 corresponds to an adjusted audio capture area of the microphone array 120. The modified field of listen 132, for instance, is generated by transforming Cartesian coordinates of the original field of listen 128 to align with the boundaries (e.g., the Cartesian coordinates) of the field of view 126. This transformation results in the field of view 126 and field of listen 128 to be defined according to a common system of Cartesian coordinates for efficient aligning. When the field of listen 128 is aligned to the field of view 126, the sound calibrator 112 can account for size differences and positional differences of the computing device 102 that cause variation in relative distances between the camera 118 and microphone array 120. Specifically, the sound calibrator 112 compensates for the positional differences between the camera position and the microphone array position, adjusting the Cartesian coordinates of the original field of listen 128 to create a virtual pyramid or cone representing the modified field of listen 132 that correlates with or is included within a corresponding pyramid or cone representing the camera field of view 126. This coordination creates a unified spatial awareness among the camera 118 and the microphone array 120, enabling the computing devices 102 to independently focus audio capture to specific areas in the environment 100 for voice detection from the user 104, while filtering out audio from other directions or along other propagation paths. The modified field of listen 132 enables the microphone array 120 to focus on sounds originating from within observable space of the camera 118, while filtering out sounds from outside this region, effectively creating a spatial filter that improves voice command accuracy and security. For example, as illustrated in FIG. 1, the computing device 102(1) projects a modified field of listen 132(1) from the microphone array 120(1) into the environment 100, which is encompassed or aligned within the field of view 106(1) of the camera 118(1). The computing device 102(2) projects a modified field of listen 132(2) from the microphone array 120(2) into the environment 100, which is encompassed or aligned within the field of view 106(2) of the camera 118(2). When the speech input 130 from the user 104 follows the sound propagation path 134, the speech input 130 is detected by the modified field of listen 132(1), and the speech input 130 is acted upon by the user interface manager 110 of the computing device 102(1). However, as illustrated, the sound propagation path 134 misses the modified field of listen 132(2) of the computing device 102(2), which causes the microphone array 120(2) and the audio interface 122 of the computing device 102(2) to filter or refrain from further sampling the sound (e.g., the speech input 130) on the sound propagation path 134.

Through implementation of the described camera based field of listen techniques, the computing devices 102 overcome common conventional challenges in voice-activated environments, such as distinguishing between multiple users, handling background noise, and preventing false activations. By aligning a visual field of view 126 with an audio field of listen 132, the computing devices 102 can accurately determine which device to allow to respond to a voice command, especially in scenarios like that in the environment 100 where the user 104 goes back and forth between interacting with one of the computing devices 102 or another at different times to perform different tasks.

FIG. 2 depicts a block diagram of a system 200 for processing sound inputs, expanding on the computing devices 102 introduced in FIG. 1. The system 200 implements sophisticated spatial processing techniques for determination of sound propagation paths 134 through vector parameterization. Connecting lines in the diagram represent data flow, which may be wired or wireless connections, including two-way or one-way communication channels.

The user interface manager 110 coordinates user interactions, managing inputs and outputs through various interfaces. The display output interface 202 generates display output 208 for displays 116, while the audio output interface 124 produces audio output 210 for speakers 114. The camera input interface 204 receives camera input 212 from cameras 118, and the audio input interface 122 processes speech input 130 from microphone array 120. The audio input interface 122 can filter sounds with propagation paths 134 that miss the field of listen 132, enhancing processing efficiency and accuracy.

The camera input interface 204 incorporates a face authenticator 214, while the audio input interface 122 includes a voice authenticator 216. This multi-factor authentication enhances security for voice-activated operations. The face authenticator 214 compares captured face images to stored facial prints, while the voice authenticator 216 compares detected sounds to voice prints of authorized users. Once a user 104 is authenticated within the field of view 126, the system 200 enables access to sensitive information via subsequent speech inputs 130 without reauthentication, streamlining the user experience while maintaining security.

A sensor interface 206 processes contextual data including sensor data 218, gaze data 220, and other sensor data 222. The sensor interface 206 analyzes proximity data, user identification data, device orientation data, and device usage history data. This contextual awareness enables informed decisions about which computing device 102 responds to voice commands in complex environments 100 with multiple users 104 and computing devices 102.

The sound calibrator 112 processes spatial audio parameters including sound propagation path 134, camera position 230, and microphone position 232. The sound calibrator 112 computes the field of view 126 as a pyramid or cone defined by horizontal (θ_{H}) and vertical (θ_{V}) field of view angles, creating a three-dimensional representation of the camera's 118 observable space. When projecting the field of listen, the sound calibrator 112 transforms coordinates of the field of view 126 to account for the offset between the camera position 230 and microphone positions 232.

Within the sound calibrator 112, the propagation path estimator 224 determines the sound propagation path 134, while the field of listen modifier 226 adjusts the field of listen 128 to align with the field of view 126. The field of listen modifier 226 applies coordinate transformations to create a virtual pyramid or cone representing the modified field of listen 132. This process follows a structured approach where the sound calibrator 112 first ensures the device has three or more microphones arranged (e.g., as three orthogonal pairs from at least four omnidirectional microphones, as three or more directional microphones) for audio localization in the at least three non-coincident axes of direction. The sound calibrator 112 then computes the camera's field of view in three-dimensional space, representing a pyramid or cone where any point (x, y, z) satisfies the constraints defined by Equations (1) and (2):

−tan(θ_{H}/2)*z≤x≤tan(θ_{H}/2)*z Equation (1)

−tan(θ_{V}/2)*z≤y≤tan(θ_{V}/2)*z Equation (2)

In the Equations (1) and (2), θ_{H} represents the horizontal field of view angle and θ_{V} represents the vertical field of view angle. The field of listen modifier 226 creates the modified field of listen 132 based on these field of view Cartesian coordinates while adjusting for the positional difference between the camera 118 and microphone array 120 locations. The audio input interface 122 applies this modified field of listen 132 as a spatial filter to sample sound sources that satisfy the virtual pyramidal or conical shape parameters.

The audio visual system 108 includes the microphone array 120 with microphones 234 (M1, M2, M3, and optional M4) arranged in at least three non-coincident axes of direction. For example, the microphones 234 include four microphones (e.g., M1, M2, M3, and M4) of three mutually orthogonal pairs, with each mutually orthogonal pair oriented about a different one of the at least three non-coincident axes (e.g., of three B-format axes, a different set of axes) of the system 200. For example, the microphones 234 include four omnidirectional microphones for detecting audio in multiple directions. This four omnidirectional microphone configuration enables sophisticated three-dimensional sound localization by analyzing signals from each orthogonal pair, which is oriented about a different non-coincident axis of direction. When each orthogonal pair is oriented about a different one of three B-format axes of the system 200, this enables comprehensive spatial coverage beyond what conventional microphone arrangements provide. As another example, the microphones 234 include three directional microphones (e.g., M1, M2, and M3 with or without M4) configured for capturing audio in each of the at least three non-coincident axes of direction. In either arrangement or in another arrangement of the microphone 234 (e.g., using other quantities or combinations of directional and omnidirectional microphones than the two mentioned above), the microphone array 120 is configured to enable the propagation path estimator 224 to perform sophisticated three-dimensional sound localization by analyzing distinct parts of detected sounds from each of the microphones 234 or mutually orthogonal pairs (e.g., analyzing signals from the first pair oriented about the first axis, the second pair about the second axis, and the third pair about the third axis). The resulting vector-based sound propagation data enables the field of listen modifier 226 to create calibrated spatial filters that align with the camera's field of view 126, enhancing the system 200 ability to distinguish relevant audio inputs from background noise.

The microphone array 120 operates within the modified field of listen 132, which is aligned with the camera's field of view 126. This alignment enables the system 200 to implement sophisticated spatial processing techniques, allowing for determination of sound propagation paths through vector parameterization. The sound calibrator 112 can compare these vectors (representing the sound propagation paths 134) against the outer dimensions of the field of listen 132 to determine whether sounds are to be processed or ignored.

When a sound is detected, the system 200 determines the origin using the microphone array 120, verifies if the sound falls within the modified field of listen 132, and correlates with visual data from cameras 118. Valid inputs are processed by the audio input interface 122 and may undergo dual authentication through voice and facial recognition. This approach enhances security for sensitive operations while maintaining usability. After initial authentication, users can access protected functions through subsequent voice commands without repeating verification steps.

The vector-based analysis of sound propagation paths enables filtering decisions, particularly useful in noisy environments with multiple users or devices. By combining spatial audio processing with visual data and sensor inputs, the system 200 effectively addresses unintended recordings, conflicting device activations, and user identification challenges in multi-device environments. Applying coordinate transformation capabilities accounts for camera-microphone offsets, ensuring accurate spatial alignment that forms the foundation for advanced audio-visual processing across various applications and device types.

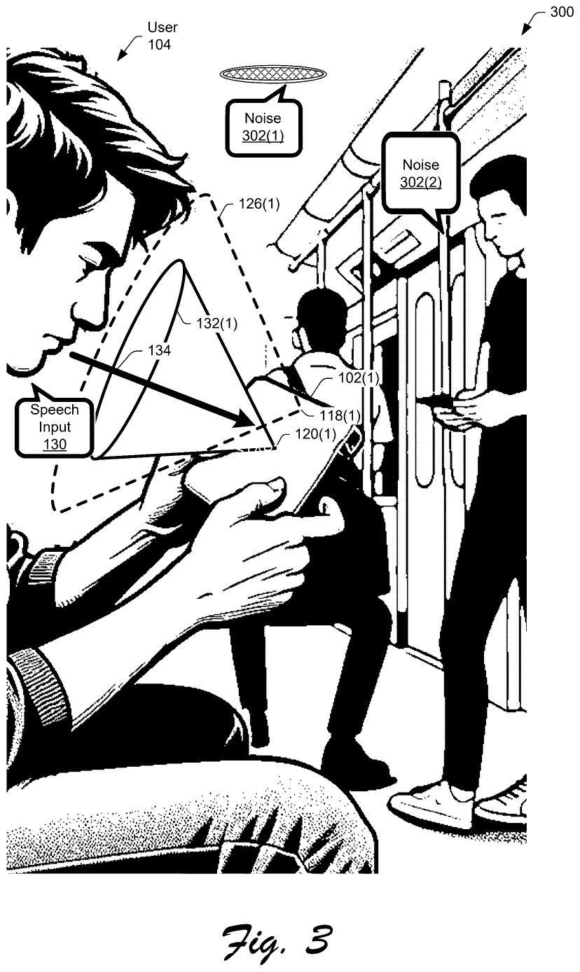

FIG. 3 illustrates a scenario 300 where a user 104, on a commercial train, uses a computing device 102(1) to work during his commute. Despite the noisy and public environment of the train, the user 104 has work to complete and cannot avoid interacting with the device 102(1), which in this example is a tablet equipped with advanced audio-visual processing capabilities. As the user 104 activates the device 102(1), the camera 118(1) and the microphone array 120(1) begin operating. The microphone array 120(1), including at least three microphones arranged in at least three non-coincident axes of direction, is designed to capture voice commands accurately. The camera 118(1) computes a field of view 126(1), projecting a three-dimensional space that includes the user and his immediate surroundings. The device 102(1) then projects a field of listen 132(1) from the microphone array 120(1), aligned within the boundaries of the camera 118 view, which creates an effective spatial filter to enhance speech input quality.

As the train journey progresses, the user 104 begins to dictate an email. His speech input 130 follows a sound propagation path 134 that enters the device's field of listen 132(1). The computing device 102(1) detects the sound and identifies the speech input 130 as the user 104 voice. The environment presents challenges in the form of noise sources. A loudspeaker above is playing a loud announcement from the conductor, representing a first noise source 302(1). To his side, another passenger is talking loudly into a speaker phone input of a mobile device, representing a second noise source 302(2). These potential interferences are examples of audio capture challenges in a commercial transportation setting. However, the computing device 102(1) does not further sample these extraneous sounds after determining the sound propagation paths 134 exhibit characteristics of noise. Propagation paths 134 of the noise 302(1) and the noise 302(2) fall outside the field of listen 132(1), making them irrelevant to the device 102(1) operations. This filtering allows the user 104 to work effectively despite the surrounding noise.

As the user 104 continues dictating, the device 102(1) captures the speech input 130 accurately. The computing device 102(1) executes commands based on the speech input 130, demonstrating enhanced accuracy due to the filtering of extraneous noise. This implementation of camera based microphone field of listen techniques improves voice command processing in the noisy environments, where multiple sound sources could potentially interfere with device operations. By the end of the train ride, the user 104 has completed his work efficiently, benefiting from the enhanced voice command processing of the device 102(1). This scenario 300 illustrates how camera based field of listen techniques enable the device 102(1) to address the challenges of working in noisy, public environments, making productive use of travel time more achievable.

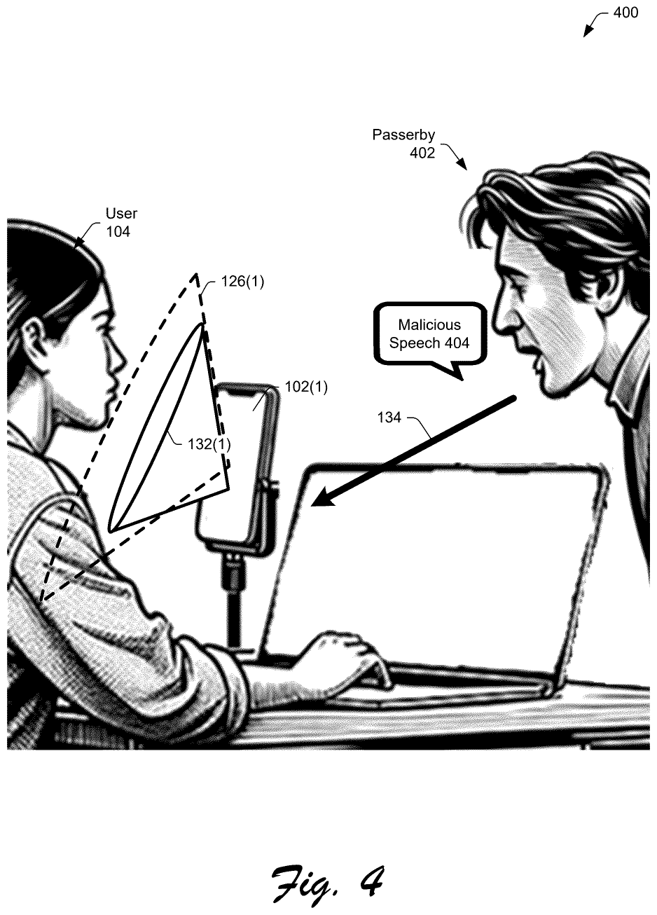

FIG. 4 illustrates a scenario 400 depicting a user 104 interacting with two computing devices 102, focusing on a first computing device 102(1). The first computing device 102(1) implements camera based microphone field of listen techniques to enhance security and accuracy of voice command processing. While conventional approaches enhance audio processing through adoption of microphone arrays, other potential security and privacy vulnerabilities may be introduced. Voice-activated devices operating in an always-listening mode raise concerns about unauthorized recordings and potential breaches of user privacy. The first computing device 102(1) projects a first field of view 126(1) using the camera 118 and establishes a first modified field of listen 132(1) using the microphone array 120. The first modified field of listen 132(1) aligns with the first field of view 126(1), creating unified spatial awareness for audio and visual inputs. The user 104 is positioned within both the first field of view 126(1) and the first modified field of listen 132(1), enabling seamless interaction with the first computing device 102(1). Additionally, this spatial filtering approach helps protect against voice spoofing attacks, where malicious actors may attempt to mimic a user's voice to gain unauthorized access to sensitive information or control of the device.

As the user 104 engages with the first computing device 102(1), a passerby 402 attempts to interfere with operations of the first computing device 102(1). The passerby 402 is positioned behind the first computing device 102(1), outside both the first field of view 126(1) and the first modified field of listen 132(1). The passerby 402 speaks malicious speech input 404, such as intending to disrupt functionality of the first computing device 102(1) or gain unauthorized access. In variations, the malicious speech input 404 is from the passerby 402 who fails to realize the user 104 engaged in a call, and the malicious speech input 404 is an example of accidental actions from the passerby 402 that can disrupt operations (e.g., the ongoing call experience) happening on the first computing device 102(1). In situations where a security risk is associated with the malicious speech input 404, in other situations where the malicious speech input 404 is from a co-worker or friend not intending harm, the techniques improve operations of the first computing device 102(1). The first computing device 102(1) determines that the sound propagation path 134 of the malicious speech input 404 misses the first modified field of listen 132(1). As a result, the first computing device 102(1) refrains from further sampling this sound, effectively ignoring the malicious speech input 404 upon further detection. This demonstrates the ability to actively listen to sample the input 404 sufficient for performing localization to filter out potential security threats originating from outside the designated interaction space from happening before further sampling of the malicious speech input 404 conveys sufficient information to cause interference with device operations.

While the noise from the passerby 402 may be annoying to the user 104 who hears the passerby 402, the malicious speech input 404 is prevented from interfering with operations due to sophisticated spatial filtering. The filtering prevents unauthorized access attempts, noise causing command word triggers, etc. may be spoken and detected as the malicious speech input 404 from the passerby 402. The alignment of the first field of view 126(1) with the first modified field of listen 132(1) enables the first computing device 102(1) to focus on legitimate user interactions while disregarding potentially malicious inputs from outside these fields. This implementation enhances both accuracy of voice command processing and the security of the system 200. By preventing unauthorized access through voice commands originating from outside the intended operational area of the first computing device 102(1), the first computing device 102(1) maintains a secure interaction environment for the user 104. Furthermore, the first computing device 102(1) may authenticate the user 104 within the first field of view 126(1) using facial recognition through the face authenticator 214. Once authenticated, the first computing device 102(1) can enable access to sensitive information via subsequent speech inputs 130 without requiring reauthentication, streamlining the user experience while maintaining robust security measures.

This scenario 400 illustrates the effectiveness of camera based microphone field of listen techniques in real-world situations where potential security threats may attempt to exploit voice-activated systems. By implementing advanced spatial awareness and filtering capabilities, the first computing device 102(1) ensures that authorized users can interact with the device, even in public or potentially compromising environments.

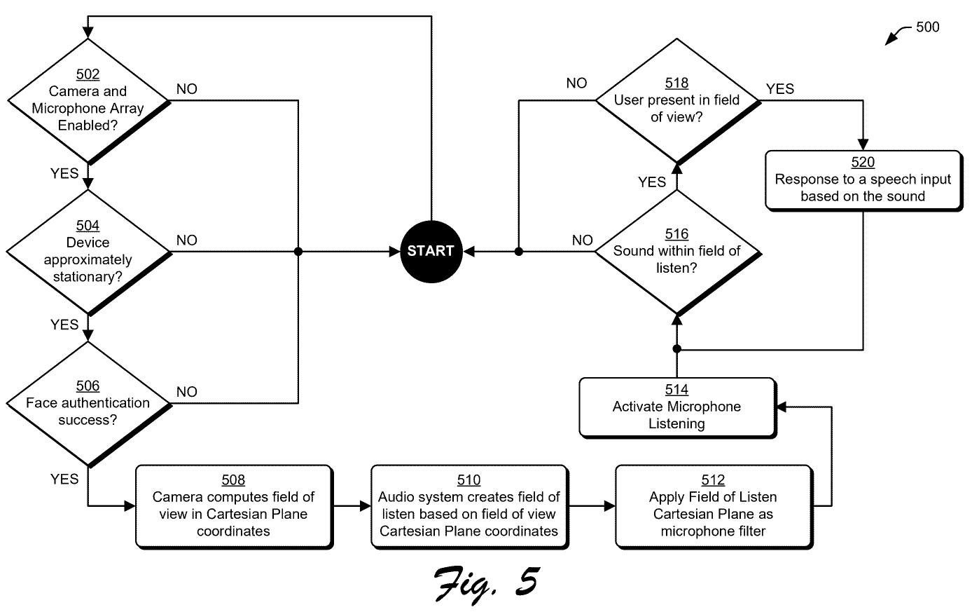

FIGS. 5, 6, and 7 each illustrate flow charts depicting example processes for camera based microphone field of listen in accordance with one or more implementations. Each process illustrated may be performed in the context of the environment 100, such as by the computing devices 102 and the system 200. The steps of each process may be performed in combination (e.g., sequentially, in-parallel), by performing steps of the processes in different orders than shown, and in variations, performed using fewer or additional steps than those depicted in the drawings.

FIG. 5 illustrates a process 500 for processing sound inputs based on camera and microphone array fields, in accordance with one or more implementations of camera based microphone field of listen. The process 500 begins with a step 502 that checks if a camera and microphone array are enabled. For example, the system 200 verifies operational status of the camera 118 and microphone array 120 to implement a speech enabled user interface that configures the system 200 to support an always-listening mode for receiving audio-visual inputs.

If the camera and microphone array are enabled (YES branch), the process 500 proceeds to step 504 to determine if the device is approximately stationary. For example, the system 200 uses sensor data 218 to determine if the computing device is in a stable position, enabling the sound calibrator 112 to create accurate spatial mappings between the camera position 230 and microphone position 232 for field of view and field of listen mapping and aligning calculations.

If the device is approximately stationary (YES branch), the process 500 moves to step 506 to check if face authentication is successful. For example, the system 200 uses the face authenticator 214 to verify identify of the user 104 through facial recognition before enabling voice-activated operations to enhance security of the system 200.

Following successful face authentication (YES branch), the process 500 proceeds to step 508 where the camera computes a field of view in Cartesian plane coordinates. For example, the camera 118 calculates the three-dimensional pyramid or cone shape defined by horizontal and vertical field of view angles that establish spatial boundaries of the field of view 126 for subsequent audio and visual processing.

The process 500 then proceeds to step 510 where the audio system creates a field of listen based on the field of view Cartesian plane coordinates. For example, the field of listen modifier 226 transforms the original field of listen 128 (e.g., a default field of listen) to align with the boundaries of the field of view 126, accounting for positional differences between the camera position 230 and microphone position 232. A three-dimensional pyramid or cone representing the modified field of listen 132 can be defined by recomputing horizontal and vertical field of view angles of the original field of listen 128 to establish spatial boundaries projected in the environment 100, which align with (e.g., at least partially overlapping with) a corresponding three-dimensional pyramid or cone defined for the field of view 126.

At step 512, the process 500 applies the field of listen Cartesian plane as a microphone filter. The audio input interface 122 may configure the microphone array 120 to isolate and further sample sounds entering the modified field of listen 132 while filtering out (e.g., refraining from further sampling) and refraining from further sampling noise from outside the modified field of listen 132, which improves capture quality of the speech input 130 from the user.

The process 500 continues to step 514 to activate microphone listening. For example, the microphone array 120 begins actively sampling audio input within the modified field of listen 132, enabling the system 200 to detect potential voice commands while maintaining spatial filtering.

At step 516, the process 500 checks if sound is within the field of listen. For example, the propagation path estimator 224 analyzes detected sounds to determine whether a sound propagation path 134 enters the modified field of listen 132, enabling discrimination between relevant and irrelevant audio inputs, such as distinguishing between speech inputs and noise (e.g., sounds directed to other devices, or originating from malicious sources, unauthorized users, background noise, etc.

If sound is within the field of listen (YES branch), the process 500 proceeds to step 518 to check if a user is present in the field of view. The camera input interface 204 may verify that a user 104 is visually detected within the field of view 126 prior to enabling voice command features of the audio enabled user interface. Ensuring correlation between the detected sound and an authorized user's presence improves security.

If a user is present in the field of view (YES branch), the process 500 moves to step 520 where a response to a speech input is generated based on further sampling the sound. For example, the user interface manager 110 processes the validated voice command through the audio input interface 122 and executes the corresponding operation. The process 500 is repeated in whole or in-part when processing subsequent secure voice interactions between the user 104 and the system 200.

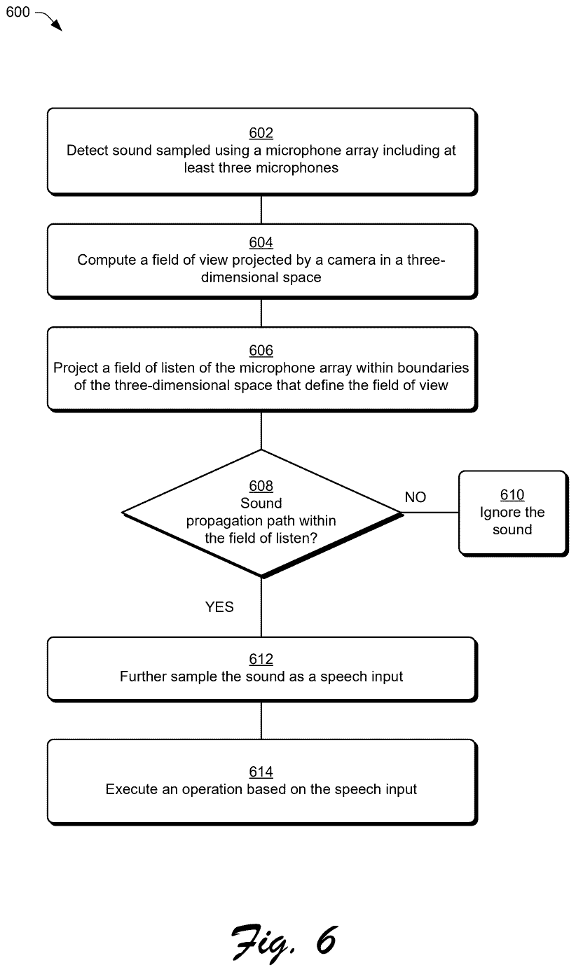

FIG. 6 illustrates a process 600 for processing sound inputs based on camera and microphone array fields, in accordance with one or more implementations of camera based microphone field of listen. Beginning with step 602, the process 600 detects sound sampled using a microphone array including at least four microphones arranged in at least three orthogonal pairs. For example, the microphone array 120 of the computing device 102 captures audio input using a three or four microphone configuration of the microphones 234 (M1, M2, M3, and M4) arranged in three non-coincident axes of direction, enabling three-dimensional sound localization as described in connection with the system 200.

At step 604, the process 600 computes a field of view projected by a camera in a three-dimensional space. For instance, the camera 118 of the computing device 102 calculates the field of view 126 as a pyramid or cone defined by horizontal and vertical field of view angles, establishing a three-dimensional representation of the observable space external to the computing device 102.

At step 606, the process 600 projects a field of listen of the microphone array within boundaries of the three-dimensional space that define the field of view. For example, the sound calibrator 112 uses the field of listen modifier 226 to transform the original field of listen 128 to create the modified field of listen 132 that aligns with the boundaries of the field of view 126, compensating for differences between the camera position 230 and microphone position 232.

At step 608, the process 600 determines whether a sound propagation path is within the field of listen. For instance, the propagation path estimator 224 analyzes the sound propagation path 134 by comparing a vector parameterization of the sound propagation path 134 to a Cartesian plane defining outer dimensions of the modified field of listen 132, enabling discrimination between relevant and irrelevant audio inputs.

If the sound propagation path is within the field of listen (YES branch), the process 600 proceeds to step 612 where the sound is further sampled as a speech input. For example, the audio input interface 122 processes the detected sound as speech input 130 when the sound propagation path 134 enters the modified field of listen 132, enabling the computing device 102 to recognize potential voice commands from the user 104.

At step 614, the process 600 executes an operation based on the speech input. For instance, the user interface manager 110 processes the validated speech input 130 through the audio input interface 122 and executes the corresponding operation on the computing device 102, completing the voice command processing sequence.

If the sound propagation path is not within the field of listen (NO branch), the process 600 moves to step 610 where the sound is ignored. For example, the audio input interface 122 refrains from further sampling the sound by filtering the sound from the microphone array 120 input when the sound propagation path 134 misses the modified field of listen 132, as demonstrated in the scenario 300 where noise sources 302(1) and 302(2) are filtered out from missing the Cartesian plane defining boundaries of the modified field of listen 132. The process 600 may be repeated in whole or in part when processing subsequent sounds detected by the microphone array 120.

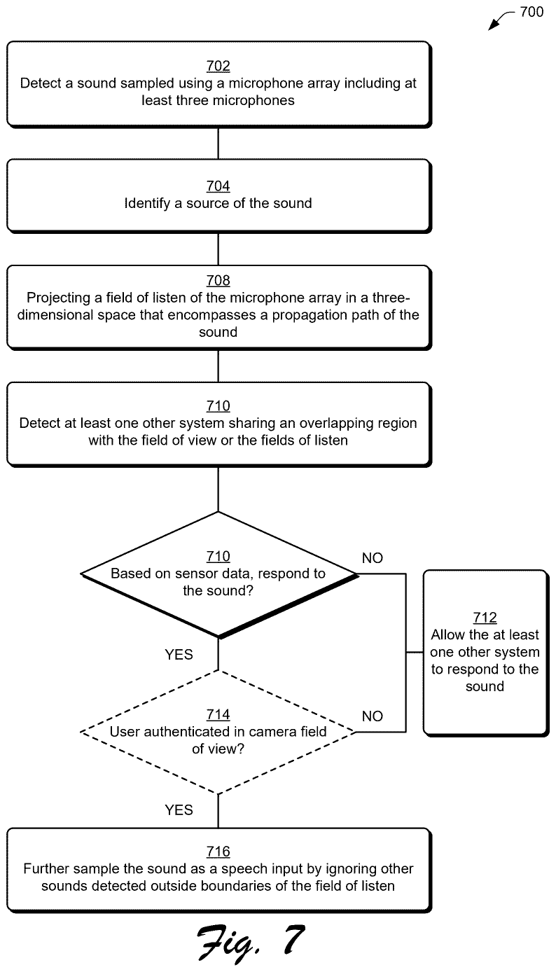

FIG. 7 illustrates a process 700 for processing sound inputs using microphone and camera systems in multi-device environments, in accordance with one or more implementations of camera based microphone field of listen. At step 702, the process 700 detects sound sampled using a microphone array including at least four microphones arranged in at least three orthogonal pairs. For example, the microphone array 120 of the computing device 102 captures audio input using at least three of the microphones 234 (M1, M2, M3, and M4) arranged in at least three non-coincident axes of direction, enabling comprehensive spatial coverage for sound detection.

At step 704, the process 700 identifies a source of the sound. For instance, the propagation path estimator 224 determines the origin of the detected sound by analyzing parts of the sound received from each of the microphones 234, with each microphone or pair of the microphones 234 providing directional information about a different non-coincident axis of direction in three-dimensional space.

At step 708, the process 700 projects a field of listen of the microphone array in a three-dimensional space that encompasses a propagation path of the sound. For example, the field of listen modifier 226 creates the modified field of listen 132 based on the identified sound source location and the field of view 126, ensuring that the sound propagation path 134 from the user 104 is properly captured within the spatial boundaries.

At step 710, the process 700 detects at least one other system sharing an overlapping region with the field of view or the field of listen. For instance, as illustrated in scenario 800, the computing device 102(1) detects that the second computing device 102(2) has an overlapping region 802 where the first field of view 126(1) or first modified field of listen 132(1) overlaps with the second field of view 126(2) or second modified field of listen 132(2).

At step 710, the process 700 determines whether to respond to the sound based on sensor data. For example, the sensor interface 206 processes gaze data 220 indicating the gaze 804 direction of the user 104, along with other sensor data 218 such as proximity data, user identification data, device orientation data, or device usage history data to determine which computing device to allow to respond to the speech input 130.

If the determination is positive (YES branch), the process 700 moves to step 714 to check if a user is authenticated in the camera field of view. For instance, the face authenticator 214 of the camera input interface 204 verifies the identity of the user 104 through facial recognition by comparing captured face images to stored facial prints, recorded observations of user physical characteristics, such as information related to clothes, glasses, gender, height, weight, age, hair style, hair color, eye color, face shape, body type, emotion, state of mood, etc., which enhances security before processing voice commands. In some examples, the camera input interface 204 verifies the identity of the user 104 based on detecting changes in camera data, e.g., changes in facial images taken at different times, changes in physical characteristics from one moment to the next, and so forth.

If user authentication at step 714 is positive (YES branch), the process 700 proceeds to step 716, where the sound is further sampled as a speech input by ignoring other sounds detected when sampling sounds outside boundaries of the field of listen. For example, the audio input interface 122 processes the validated sound as speech input 130 while filtering out sounds from outside the modified field of listen 132, enabling the computing device 102 to focus on the authenticated user's voice commands. In variations, the step 714 also includes using camera data from the camera input interface 204 to further authenticate the speech input 130 to the user 104 through verifying that lip movements of the user 104 are synchronized with lip shapes of the user 104 (people generally) that correspond to the sounds of the speech input 130, to further build confidence for the voice to be sampled

If the determination at step 710 is negative (NO branch), the process 700 proceeds to step 712, where the at least one other system is allowed to respond to the sound. For instance, based on the gaze data 220 showing that the user's gaze 804 is directed toward the second computing device 102(2) as illustrated in scenario 800, the first computing device 102(1) refrains from executing operations in response to the speech input 130, allowing the second computing device 102(2) to further sample the sound and process the voice command instead. The process 700 may be repeated in whole or in part when processing subsequent interactions between the user 104 and multiple computing devices in the environment 100.

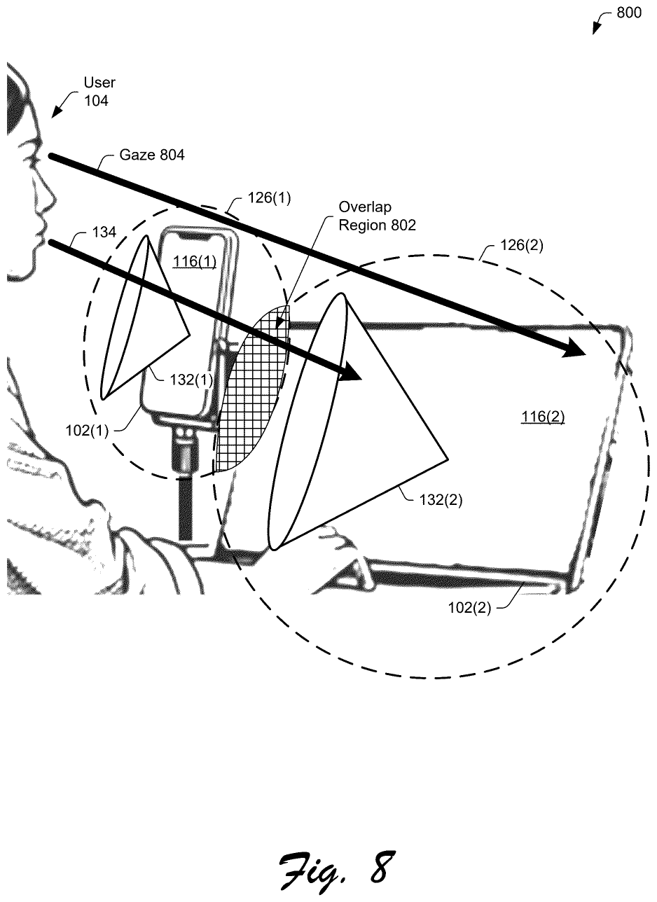

FIG. 8 illustrates a scenario 800 demonstrating interaction between multiple computing devices and a user, in accordance with one or more implementations of camera based microphone field of listen. The scenario 800 provides a side view representation of how the system 200 resolves potential conflicts when multiple devices 102 are capable of responding to the same speech input 130.

In the scenario 800, the user 104 is positioned within proximity of each of the computing devices 102. For purposes of this example, each computing device 102(1) and computing device 102(2) incorporates the audio visual system 108 described in connection with FIG. 1, including displays 116, cameras 118, and microphone arrays 120. Specifically, the first computing device 102(1) includes a first display 116(1) while the second computing device 102(2) includes a second display 116(2).

The cameras 118 of each computing device project their respective fields of view into the three-dimensional space surrounding the devices 102. The first computing device 102(1) projects a first field of view 126(1), while the second computing device 102(2) projects a second field of view 126(2). Correspondingly, the sound calibrator 112 of each device has generated a modified field of listen that aligns with its respective field of view. The first computing device 102(1) projects a first modified field of listen 132(1) that aligns with the boundaries of the first field of view 126(1). Similarly, the second computing device 102(2) projects a second modified field of listen 132(2) that aligns with the boundaries of the second field of view 126(2).

The scenario 800 illustrates an overlap region 802 where the first field of view 126(1) and the first modified field of listen 132(1) of the first computing device 102(1) intersect with the second field of view 126(2) and the second modified field of listen 132(2) of the second computing device 102(2). This overlap region 802 creates a potential conflict zone where both devices are potential targets for responding to the same speech input 130 from the user 104. When multiple voice-activated devices operate in proximity, conflicting speech input activations can occur as conventional systems of the multiple devices struggle to determine whether to respond or allow the other device to respond to a particular voice command. This can lead to unintended device activations and potential security risks in shared spaces or public environments, particularly when the devices cannot directly coordinate due to incompatible operating systems or platforms.

When the user 104 speaks, the resulting speech input 130 travels along a sound propagation path 134 that passes through the overlap region 802. The propagation path estimator 224 of each computing device determines that the sound propagation path 134 enters both the first modified field of listen 132(1) and the second modified field of listen 132(2). In a conventional approach without additional disambiguation, characteristics of the sound propagation path 134 cause both devices 102 to attempts to process and respond to the same speech input 130.

To resolve this conflict, the sensor interface 206 of each computing device processes sensor data 218, particularly gaze data 220 that indicates the direction of the user's gaze 804. In this scenario, the gaze 804 of the user 104 is directed toward the second computing device 102(2). The system 200 determines that despite both devices 102 detecting the sound propagation path 134 within their respective modified fields of listen 132(1) and 132(2), the attention of the user 104 is focused on the second computing device 102(2) as indicated by the gaze 804 direction. This process of detecting nearby devices with overlapping fields and determining which device to allow to respond based on sensor data can apply the approach described in connection with FIG. 7. The computing devices 102, for instance, implement steps 710 and 712 of process 700.

Based on this determination, the second computing device 102(2) proceeds to further sample the sound as speech input 130 and executes the corresponding operation through the user interface manager 110. Concurrently, the first computing device 102(1) detects that another system (the second computing device 102(2)) shares an overlapping region with its field of view and field of listen. The first computing device 102(1) processes the gaze data 220 and determines not to respond to the sound. Consequently, the first computing device 102(1) refrains from executing operations in response to the speech input 130, allowing the second computing device 102(2) to handle the user's command without effecting the computing device 102(1) (e.g., as described in step 712). The scenario 800 effectively demonstrates how the camera based microphone field of listen techniques address the challenge of disambiguating the correct recipient of voice commands in environments with multiple computing devices. By integrating spatial awareness through the modified fields of listen with contextual information such as user gaze direction, the devices 102 enable an intuitive and accurate voice interaction experience even when the multiple devices 102 operate in close proximity.

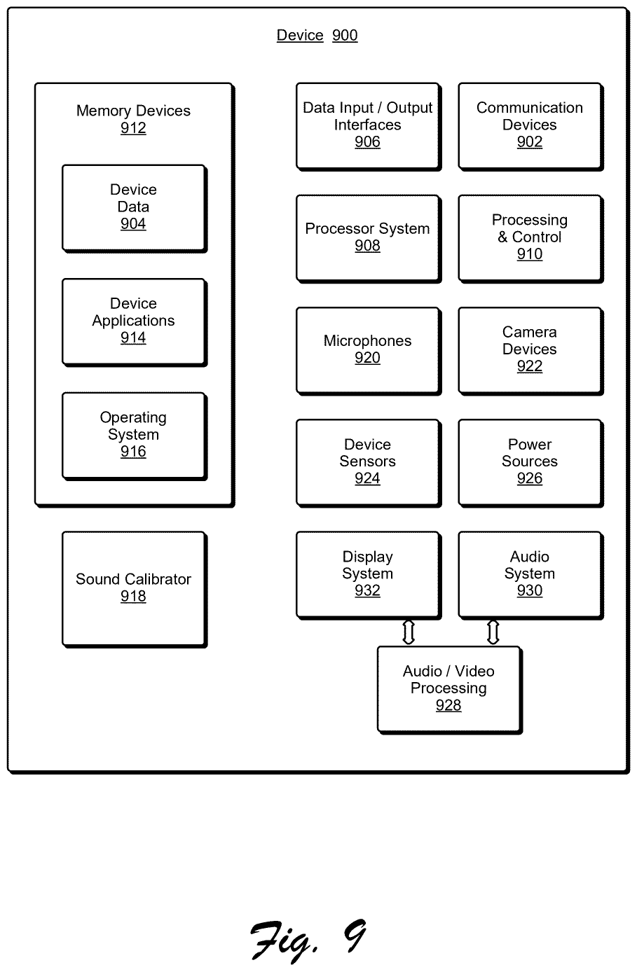

FIG. 9 illustrates various components of an example device 900 in which aspects of camera based microphone field of listen can be implemented in accordance with one or more implementations. The device 900 can be implemented as any of the devices described with reference to the previous FIGS. 1-8, such as any type of computing device, including mobile devices such as a mobile phone, a wearable device, a tablet, an electronic device, communication device, entertainment device, gaming device, media playback device, computing system, a server, and/or other type of device. For example, aspects of the computing devices 102 and/or the system 200, as shown and described with reference to FIGS. 1-8, may be implemented as the example device 900.

The device 900 includes communication devices 902 that enable wired and/or wireless communication of device data 904 with other devices. The device data 904 can include device identifying data, device location data, wireless connectivity data, and wireless protocol data. Additionally, the device data 904 can include audio, video, and/or image data, such as sounds, speech input, etc. The device data 904 can include communication data, such as radio measurements and radio messages. Example communication devices 902 include wireless personal area network (WPAN) radios compliant with various IEEE 802.15 (Bluetooth™) standards, wireless local area network (WLAN) radios compliant with any of the various IEEE 802.11 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 900 may also include one or more data input/output interfaces 906 via which any type of data, media content, and/or inputs can be received, such as user-selectable inputs to the device, messages, music, television content, recorded content, and any other type of audio, video, and/or image data received from any content and/or data source. The data input/output interfaces 906 may include USB ports, coaxial cable ports, and other serial or parallel connectors (including internal connectors) for flash memory, DVDs, CDs, and the like. These data input/output interfaces 906 may be used to couple the device to any type of components, peripherals, or accessories such as microphones and/or cameras.

The device 900 includes a processing system 908 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing & control 910. The device 900 may further include any type of a system bus or other data and command transfer system that couples the various components within the device. A system bus can include any one or combination of different bus structures and architectures, as well as control and data lines.

The device 900 also includes computer-readable storage configured as memory using one or more memory devices 912 that enable data storage, such as data storage devices that can be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random access memory (RAM), read-only memory (ROM), flash memory, and other types of storage media in various memory device configurations. The device 900 may also include a mass storage media device. Memory devices 912 represent media and/or devices that enable persistent and/or non-transitory storage of information in contrast to mere signal transmission, carrier waves, or signals per se. Memory devices 912 do not include signals per se or transitory signals.

The memory devices 912 provide data storage mechanisms to store the device data 904, other types of information and/or data, and various device applications 914 (e.g., software applications). The device applications 914 include the user interface manager 110 and the sound calibrator 918, for instance. As another example of device programs maintained in the memory devices 912 include instructions for an operating system 916. The operating system 916, for example, implements aspects of the user interface manager 110 and the sound calibrator 918 to execute communications (e.g., audio calls, video calls, telephone calls, live streams). The instructions can be maintained as software instructions within the memory devices 912 and executed by the processing system 908. When executed, the instructions cause the processing system 908 to execute the device applications 914, which may also include a device manager, such as any form of a control application, software application, signal-processing and control module, code that is native to a particular device, a hardware abstraction layer for a particular device, and so on.

In this example, the example device 900 also includes camera devices 922 and device sensors 924, including motion sensors, such as may be implemented in an inertial measurement unit (IMU). The motion sensors can be implemented with various sensors, such as the device sensors 924, for example, including a gyroscope, an accelerometer, and/or other types of motion sensors to sense motion of the device. The various motion sensors may also be implemented as components of an inertial measurement unit in the device. The device 900 also includes microphones 920, which is representative of functionality to perform various audio capture tasks, such as through a remote service accessed from a network connection established to a network. The camera devices 922 and the device sensors 924 may collaborate to implement a cohesive security framework encompassing facial recognition, voice recognition, and other authentication features.

The device 900 can also include one or more power sources 926, such as when the device is implemented as a mobile device. The power sources 926 may include a charging and/or power system, and can be implemented as a flexible strip battery, a rechargeable battery, a charged super-capacitor, and/or any other type of active or passive power source.

The device 900 also includes an audio/video processing 928 that generates audio data for an audio system 930 and/or generates display data for a display system 932. The audio system 930 and/or the display system 932 may include any devices that process, display, and/or otherwise render audio, video, display, and/or image data. For example, speakers and microphones are shown as part of the audio system 930. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link. In some implementations, the audio system and/or the display system are integrated components of the example device. Alternatively, the audio system and/or the display system are external, peripheral components to the example device.

Although implementations of device orientation based on sound have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional examples of the techniques, features, and/or methods discussed herein relate to one or more of the following aspects.

In some aspects, the techniques described herein relate to a computing device, including: at least one memory; and at least one processor coupled with the at least one memory and configured to cause the computing device to: detect sound sampled using a microphone array including at least three microphones; compute a field of view projected by a camera in a three-dimensional space external to the computing device; project a field of listen of the microphone array within boundaries of the three-dimensional space that define the field of view; further sample the sound as a speech input based on whether a sound propagation path of the sound enters the field of listen or misses the field of listen; and execute an operation of the computing device based on the speech input.

In some aspects, the techniques described herein relate to a computing device, wherein the at least one processor is further configured to cause the computing device to: determine whether the sound propagation path enters the field of listen or misses the field of listen; further sample the sound as the speech input in response to determining that the sound propagation path enters the field of listen; and refrain from further sampling the sound in response to determining that the sound propagation path misses the field of listen.

In some aspects, the techniques described herein relate to a computing device, wherein the at least one processor is further configured to cause the computing device to: identify a source of the sound; and compute the sound propagation path in response to identifying the source of the sound.

In some aspects, the techniques described herein relate to a computing device, wherein the at least one processor is further configured to cause the computing device to: determine whether the sound propagation path enters the field of listen or misses the field of listen by comparing a vector parameterization of the sound propagation path to outer dimensions of the field of listen.

In some aspects, the techniques described herein relate to a computing device, wherein to project the field of listen the at least one processor is configured to cause the computing device to compensate for differences between a camera position and at least one microphone position of the microphone array.

In some aspects, the techniques described herein relate to a computing device, wherein the camera includes an always-on-camera configured to capture the field of view when executing operations based on user inputs.

In some aspects, the techniques described herein relate to a method performed by a computing device, the method including: detecting sound sampled using a microphone array including at least three microphones; computing a field of view projected by a camera in a three-dimensional space external to the computing device; projecting a field of listen of the microphone array within boundaries of the three-dimensional space that define the field of view; further sampling the sound as a speech input in response to determining that a sound propagation path of the sound enters the field of listen; and executing an operation based on the speech input.

In some aspects, the techniques described herein relate to a method, further including: detecting a second sound; and refraining from further sampling the second sound in response to determining that a corresponding propagation path of the sound misses the field of listen by filtering the second sound from an input to the microphone array.

In some aspects, the techniques described herein relate to a method, wherein the at least three microphones are arranged on a linear axes for obtaining the sound propagation path based on adaptive processing of the sound.

In some aspects, the techniques described herein relate to a method, wherein the at least three microphones include four or more omnidirectional microphones arranged in at least three mutually orthogonal pairs defining the at least three non-coincident axes of direction for obtaining the sound propagation path.

In some aspects, the techniques described herein relate to a method, wherein the at least three microphones include three directional microphones configured for capturing audio in each of the at least three non-coincident axes of direction for obtaining the sound propagation path.

In some aspects, the techniques described herein relate to a method, further including: authenticating a user of the computing device prior to executing the operation based on the speech input.

In some aspects, the techniques described herein relate to a method, wherein the authenticating includes at least one of: comparing the sound to a voice print of the user; or using facial recognition based on a face image captured by the camera to a facial print of the user.

In some aspects, the techniques described herein relate to a system, including: at least one memory; and at least one processor coupled with the at least one memory and configured to cause the system to: detect sound sampled using a microphone array including at least three microphones; compute a field of view projected by a camera in a three-dimensional space external to the system; project a field of listen of the microphone array within boundaries of the three-dimensional space that define the field of view; detect one or more nearby computing devices having overlapping fields of view or fields of listen with the system; determine which of the system or the one or more nearby computing devices to allow to respond to the sound based on sensor data; and further sample the sound as a speech input in response to determining to allow the system to respond to the sound.

In some aspects, the techniques described herein relate to a system, wherein the sensor data includes gaze data indicating a user gaze direction.

In some aspects, the techniques described herein relate to a system, wherein the at least one processor is further configured to cause the system to: determine that a sound propagation path of the sound enters the field of listen; and determine that the sound propagation path enters an overlap region where the field of listen of the system overlaps with a field of listen of at least one of the one or more nearby computing devices.

In some aspects, the techniques described herein relate to a system, wherein the at least one processor is further configured to cause the system to: execute an operation based on the speech input in response to determining to allow the system to respond to the sound; and refrain from executing the operation in response to determining to allow one of the one or more nearby computing devices to respond to the sound.

In some aspects, the techniques described herein relate to a system, wherein the sensor data includes at least one of proximity data, user identification data, device orientation data, or device usage history data.

In some aspects, the techniques described herein relate to a system, wherein the at least one processor is further configured to cause the system to: authenticate a user within the field of view using facial recognition; and enable access to sensitive information via subsequent speech inputs without reauthenticating the user.

In some aspects, the techniques described herein relate to a system, wherein the at least one processor is further configured to cause the system to: compute the field of view as a pyramid or cone defined by horizontal and vertical field of view angles; and transform coordinates of the field of view to account for an offset between a camera position and at least one microphone position when projecting the field of listen to define a corresponding pyramid or cone.

What is claimed is:

1. A computing device, comprising:
at least one memory; and
at least one processor coupled with the at least one memory and configured to cause the computing device to:
detect sound sampled using a microphone array including at least three microphones;
compute a field of view projected by a camera in a three-dimensional space external to the computing device;
project a field of listen of the microphone array within boundaries of the three-dimensional space that define the field of view;
further sample the sound as a speech input based on whether a sound propagation path of the sound enters the field of listen or misses the field of listen; and
execute an operation of the computing device based on the speech input.

2. The computing device of claim 1, wherein the at least one processor is further configured to cause the computing device to:
determine whether the sound propagation path enters the field of listen or misses the field of listen;
further sample the sound as the speech input in response to determining that the sound propagation path enters the field of listen; and
refrain from further sampling the sound in response to determining that the sound propagation path misses the field of listen.

3. The computing device of claim 1, wherein the at least one processor is further configured to cause the computing device to:
identify a source of the sound; and
compute the sound propagation path in response to identifying the source of the sound.

4. The computing device of claim 1, wherein the at least one processor is further configured to cause the computing device to:
determine whether the sound propagation path enters the field of listen or misses the field of listen by comparing a vector parameterization of the sound propagation path to outer dimensions of the field of listen.

5. The computing device of claim 1, wherein to project the field of listen the at least one processor is configured to cause the computing device to compensate for differences between a camera position and at least one microphone position of the microphone array.

6. The computing device of claim 1, wherein the camera comprises an always-on-camera configured to capture the field of view when executing operations based on user inputs.

7. A method performed by a computing device, the method comprising:
detecting sound sampled using a microphone array including at least three microphones;
computing a field of view projected by a camera in a three-dimensional space external to the computing device;
projecting a field of listen of the microphone array within boundaries of the three-dimensional space that define the field of view;
further sampling the sound as a speech input in response to determining that a sound propagation path of the sound enters the field of listen; and
executing an operation based on the speech input.

8. The method of claim 7, further comprising:
detecting a second sound; and
refraining from further sampling the second sound in response to determining that a corresponding propagation path of the sound misses the field of listen by filtering the second sound from an input to the microphone array.

9. The method of claim 7, wherein the at least three microphones are arranged on a linear axes for obtaining the sound propagation path based on adaptive processing of the sound.

10. The method of claim 7, wherein the at least three microphones include four or more omnidirectional microphones arranged in at least three mutually orthogonal pairs defining at least three non-coincident axes of direction for obtaining the sound propagation path.

11. The method of claim 7, wherein the at least three microphones include three directional microphones configured for capturing audio in each of at least three non-coincident axes of direction for obtaining the sound propagation path.

12. The method of claim 7, further comprising:
authenticating a user of the computing device prior to executing the operation based on the speech input.

13. The method of claim 12, wherein the authenticating includes at least one of:
comparing the sound to a voice print of the user; or
using facial recognition based on a face image captured by the camera to a facial print of the user.

14. A system, comprising:
at least one memory; and
at least one processor coupled with the at least one memory and configured to cause the system to:
detect sound sampled using a microphone array including at least three microphones;
compute a field of view projected by a camera in a three-dimensional space external to the system;
project a field of listen of the microphone array within boundaries of the three-dimensional space that define the field of view;
detect one or more nearby computing devices having overlapping fields of view or fields of listen with the system;
determine which of the system or the one or more nearby computing devices to allow to respond to the sound based on sensor data; and
further sample the sound as a speech input in response to determining to allow the system to respond to the sound.

15. The system of claim 14, wherein the sensor data includes gaze data indicating a user gaze direction.

16. The system of claim 14, wherein the at least one processor is further configured to cause the system to:
determine that a sound propagation path of the sound enters the field of listen; and
determine that the sound propagation path enters an overlap region where the field of listen of the system overlaps with a field of listen of at least one of the one or more nearby computing devices.

17. The system of claim 14, wherein the at least one processor is further configured to cause the system to:
execute an operation based on the speech input in response to determining to allow the system to respond to the sound; and
refrain from executing the operation in response to determining to allow one of the one or more nearby computing devices to respond to the sound.

18. The system of claim 14, wherein the sensor data includes at least one of proximity data, user identification data, device orientation data, or device usage history data.

19. The system of claim 14, wherein the at least one processor is further configured to cause the system to:
authenticate a user within the field of view using facial recognition; and
enable access to sensitive information via subsequent speech inputs without reauthenticating the user.

20. The system of claim 14, wherein the at least one processor is further configured to cause the system to:
compute the field of view as a pyramid or cone defined by horizontal and vertical field of view angles; and
transform coordinates of the field of view to account for an offset between a camera position and at least one microphone position when projecting the field of listen to define a corresponding pyramid or cone.
